(19) United States
(12) Patent Application Publication
(10) Pub. No.: US 2011/0008133 A1
(43) Pub. Date: Jan. 13, 2011

(54) Device for applying glue onto a book block

(76) Inventors: Andreas Walther, Bunde (DE); Christian Heiner Müller, Lubbecke (DE)

Correspondence Address: ALIX YALE & RISTAS LLP, 750 MAIN STREET, SUITE 1400, HARTFORD, CT, 06103, US

(21) Appl. No.: 12/802,826

(22) Filed: Jun. 15, 2010

(30) Foreign Application Priority Data
Jul. 7, 2009 (DE) 10 2009 031 949.2

(51) Int. Cl. B42C 9/00

(52) U.S. Cl. 412/37

(57) ABSTRACT

The invention pertains to a device for applying glue (3) onto book blocks (2) that are moved past the device in a transport mechanism (11), particularly for applying glue onto the book block spine (2a). The device includes a glue basin (4), at least one application roller (5, 5.1, 5.2) that dips into the glue basin (4) and rolls on the book block (2) with its circumference, and a scraper (7) that can be adjusted with respect to its distance (s) from the application roller (5, 5.1, 5.2) and thusly defines the thickness of the glue layer to be transferred onto the book block (2). The scraper (7) is arranged or realized on a coupler (24, 64) of an at least four-bar coupling or guiding mechanism (20, 60). The grounded links (22, 23) of the coupling mechanism (20) are preferably realized in the form of bending rods that are firmly clamped in place on both ends.

### BACKGROUND

The present invention pertains to a device for applying glue onto a book block.

Book blocks typically consist of gathered folded sections and/or single sheets that are moved past a gluing device in a transport mechanism, particularly for applying glue onto the book block spine. The gluing device features a glue basin, at least one application roller that dips into the glue basin and rolls on the book block with its circumference, and a scraper that can be adjusted with respect to its distance from the application roller and thusly defines the thickness of the glue layer to be transferred onto the book block.

In the manufacture of bookbinding end products that feature a book block, the book block is initially gathered from individual folded sections and/or single sheets, then processed on the book block spine with milling tools or sewn and subsequently connected with glue, wherein a cover or a lining may, if applicable, also be glued to the book block spine. In order to apply the glue, the book block is laterally clamped in a transport mechanism such that the block spine protrudes downward and moved past a stationary glue application device along the spine.

There exist roller-type gluing stations [see Industrielle Buchbinderei; Dieter Liebau, Inés Heinze; 2^{nd} Edition 2001, Beruf+Schule Publishing, ltzehoe; Page 284 f.] with two successively arranged application rollers that dip into a glue basin, wherein these application rollers roll on the book block spine due to their rotation in the same direction as the block transport direction and transfer the glue onto the spine during this process. The glue quantity or the thickness of the glue layer being applied is defined by a scraper that can be adjusted with respect to its distance from the application roller. An application length can be defined by closing and opening this transport gap accordingly. To this end, different scraper controls have been disclosed, in which the scraper is arranged on a pivoted scraper shaft that features a lever on its end.

It is known to realize the control by means of rotationally driven cam plates that act upon the lever. In order to change the application position, particularly the application length, the cam plates need to be adjusted relative to one another and relative to the machine cycle. Differential gears that can be actuated manually or with servomotors are provided for this purpose. Radial cams have the disadvantage that they cannot be realized with the gradient required for a steep change of the glue layer thickness on the application roller.

In DE 10242260 A1, the scraper shafts are driven pneumatically by means of contraction hoses that shorten under pressure. A defined opening gap can be adjusted by varying the pressure. According to DE 10242259 A1, the scraper shafts are driven by means of piezo-ceramic actuators.

In the scraper control according to EP 1 208 998 B1, the pivoted scraper shaft is directly connected to and driven by a driving element of a controllable electric motor. This makes it possible to vary the application position, application length and application thickness by means of the machine control. In EP 1 873 964 A1, the lever of the scraper shaft is positively connected to a radial cam connected to and driven by a motor. A desired distance of the scraper from the application roller can be adjusted by turning the cam plate within a working range.

Pivoted scraper shafts have the disadvantage that they restrict the constructive design options of the movement to and from the application roller, particularly of the path of the scraper toward the application roller. The transfer of the drive or control movement to the pivoting scraper shaft is particularly complicated with linearly acting drives because additional transmission and/or coupling elements are required. It is also disadvantageous that the scraper shafts only carry out relatively short forward and backward pivoting movements in rapid succession such that the pivot bearings can quickly wear out and the desired distance of the scraper from the application roller can no longer be exactly adjusted. Bearings and/or slideways on the gluing station, whether linear or rotative, are furthermore subjected to significant soiling with overflowing glue, glue vapors and condensates, as well as paper dust, such that the smooth running and the service life of the bearings are additionally diminished.

### SUMMARY

The present invention is based on the objective of providing a device for applying glue in which the design options of the scraper movement are expanded and an exact and reliable adjustment of the scraper can be realized with a simple construction.

This objective is attained in that the scraper is arranged or realized on a coupler of an at least four-bar coupling or guiding mechanism. The point path or trajectory of the scraper edge defining the distance from the application roller can be designed arbitrarily by realizing the coupling mechanism accordingly, e.g., with respect to the rigid frame bearings and the dimensions of the elements of mechanism. This makes it possible, for example, to realize a radial movement to and from the application roller. The coupling movement may be realized linearly, translatory or rotatory or in the form of a combination of these movements.

The coupling mechanism preferably features grounded links that are realized in the form of bending rods, both ends of which are firmly clamped in place, such that wear-prone (pivot) bearings and/or slideways are eliminated. The robust guiding mechanism is tolerant to soiling and therefore safe from any type of contamination or soiling. The bending rods may also stand in the glue basin. It is possible to utilize bending rods because the scraper only needs to be moved with a relatively short stroke such that only small excursions of the bending rods are required.

According to one preferred additional development, the bending rods are realized in the form of leaf springs that are arranged parallel to the axis of the application roller with their leaf surface. This arrangement results in a high torsional stiffness about the two axes that respectively lie transverse to the rotational axis of the application roller such that the scraper edge always extends parallel to the application roller.

The coupling mechanism is preferably realized in the form of a parallel rod mechanism with grounded links of equal length such that a purely translatory movement of the coupler or the scraper takes place. If the coupling mechanism is used in the region of the summit of the coupling movement, an essentially linear movement of the coupler or scraper is achieved.

According to one preferred additional development, the coupling mechanism is arranged outside the glue basin, wherein the coupler or scraper is realized such that it protrudes transverse to the plane of movement and supported by at least one additional grounded link or a congruent coupling mechanism on its end. The glue basin is freely accessible and only traversed by the scraper. The coupling mechanism with the scraper preferably is rigidly arranged on a removable glue basin.

The distance of the scraper from the application roller can be easily controlled with the direct drive of the coupler. Motor-driven radial cams or pneumatic or electric actuators may be used. The driving power is directly transmitted to the scraper rather than by means of grounded links, couplers and/or levers that are afflicted with elasticity and/or play.

In order to control the distance of the scraper from the application roller, the coupler is preferably driven by at least one gearless, linear electric direct drive. This makes it possible to change the application position, application length and application thickness by means of the machine control. Due to the short stroke of the coupler, one component of the direct drive may be arranged stationarily. The occurring changes in parallelism and the distance of the two components relative to one another are minimal and lie within the tolerance of the contactless direct drive.

A constructively simple variation is achieved if the secondary component of the direct drive with the permanent magnets is arranged or realized on the coupler. This eliminates the need to install any connecting lines on the moving coupler.

The primary component with the electric excitation coils preferably is stationarily arranged on the side of the coupler that lies opposite of the grounded links. The magnetic forces of attraction between the primary and the secondary component of the direct drive do not subject the grounded links to buckling stresses, but rather to tensile stresses, such that a constructively simple and therefore more dynamic coupling or guiding mechanism can be realized.

In another embodiment, the primary component is arranged on a receptacle device for the removable glue basin that features the coupling mechanism. When the glue basin is removed, the contactless direct drive is separated and the functional surfaces of both components are accessible for inspection and cleaning purposes. When using glue basins that can be alternately inserted, only a single hard-wired primary component with the electric excitation coils is required while one respective coupling mechanism with the secondary component featuring the permanent magnets is arranged on the alternately used glue basins.

When the direct drive is switched off, it is advantageous that the scraper is in a neutral position, in which the scraper has a definable distance from the application roller. This distance may also be equal to zero. This simplifies the exchange of the glue basins and a fail-safe state is achieved in case the direct drive fails.

It is advantageous to carry out a calibration process, in which the zero position for completely scraping the glue off the application roller can be defined. This makes it possible to automatically compensate the wear of the scraper edge.

### BRIEF DESCRIPTION OF THE DRAWING

Exemplary embodiments of the inventive device are described in greater detail below with reference to the drawing, in which:

FIG. 1 shows a two-roller glue application device with scrapers that are arranged on coupling mechanisms and linear motors that serve as drives for the scrapers;

FIG. 2 shows a side view of the glue application device according to FIG. 1;

FIG. 3 shows a representation of the glue application device according to FIG. 1 that is limited to the scraper device and the application roller;

FIG. 4 shows the scraper device according to FIG. 3 with a scraper drive that is realized in the form of a cam driven by a servomotor;

FIG. 5 shows the scraper device according to FIG. 3 with a scraper drive in the form of a moving coil; and

FIG. 6 shows a second embodiment of a coupling mechanism with a scraper drive that is realized in the form of a cam driven by a servomotor.

### DETAILED DESCRIPTION

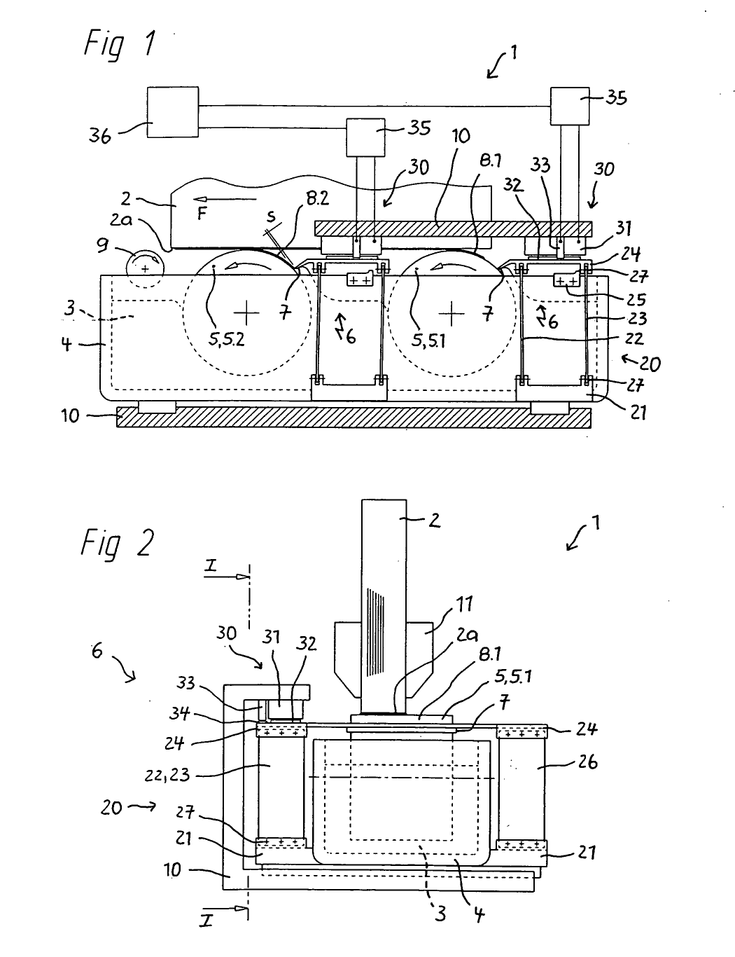

FIGS. 1 and 2 show a gluing station 1 for a perfect binding system, in which book blocks 2 gathered from folded sections and/or single sheets are bound in the spine 2a. The book blocks 2 are transported in the transport direction F in clamps 11 of a transport device. The glue is applied onto the downwardly protruding spines 2a while they pass the gluing station 1.

The gluing station 1 includes two successively arranged application rollers 5 that rotate in the same direction as the transport direction F. They dip into a basin 4 that is filled with glue 3, pick up glue 3 with their outer surface and trans-fer the glue 3 onto the book block spine 2a in the form of a rolling movement. A thin glue layer is applied with the first application roller 5.1. The glue application for stabilizing the book block spine 2a is realized by applying a thicker glue layer with the second application roller 5.2. The applied glue layer is ultimately smoothed out by means of a spinner 9 that rotates in the opposite direction.

The respective glue layers 8.1 and 8.2 to be transferred onto the book block spine 2a are defined by a scraper 7 that can be adjusted with respect to its distance s from the application roller 5. Excess glue 3 is scraped off the application roller 5 by the scraper 7 and flows back into the basin 4. An application length can be defined by closing and opening this transport gap accordingly. This is necessary in order to prevent glue from being applied onto the end regions at the head and the foot of the book block spine 2a.

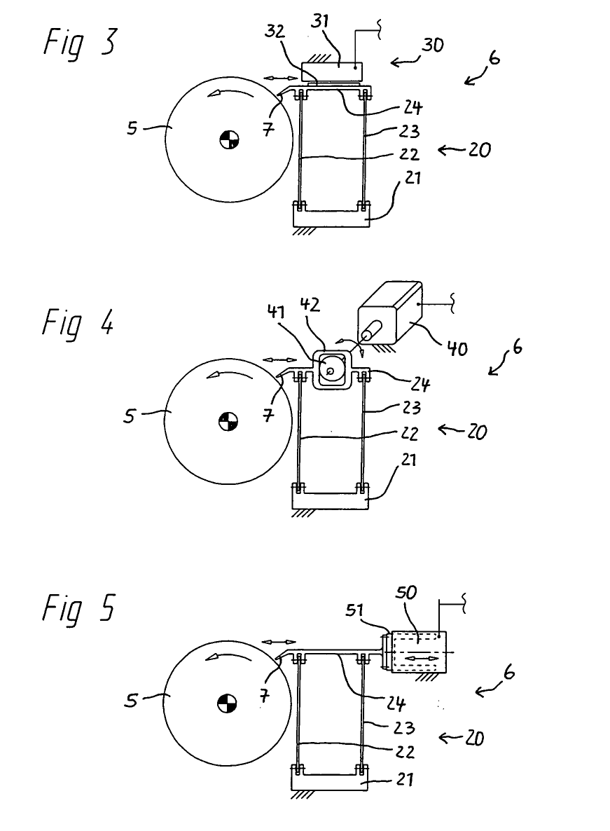

The actuation of the scraper 7 is realized with a scraper device 6 (see also FIG. 3) comprising a four-bar coupling mechanism 20 that serves as the guide mechanism for the scraper 7 and a linear motor 30 that serves as the drive. As is well known, a four bar coupling mechanism (four bar linkage) has a ground link (or frame), two grounded links (e.g., connected to the frame), and a coupler link (which has no direct connection to the frame). The two grounded links 22, 23 are preferably realized in the form of bending rods or plates accommodated on frame 21 of the coupling mechanism 20 arranged on the basin 4 and firmly clamped in place in fixtures 27. The other ends of the grounded links 22, 23 are accommodated and also firmly clamped in place in fixtures 27 on coupler 24, on which the scraper 7 is respectively arranged or realized. The guide mechanism for the scraper 7 does not feature any wear-prone (pivot) bearings and/or slideways.

The coupling mechanism 20 is realized in the form of a parallel rod mechanism with grounded links 22, 23 of equal length. Consequently, the coupler 24 and the scraper 7 respectively carry out a purely translatory movement, wherein the relatively short stroke of the scraper 7 that amounts to only a few millimeters essentially extends linearly in the region of the summit of the coupling movement. This makes it possible to directly actuate the coupler 24 with the linear motor 30 or, alternatively, with a moving coil 50 (see below).

According to FIGS. 1 and 2, the grounded links 22, 23 are realized in the form of substantially planar leaf springs that are arranged with the planar surfaces parallel to the axis of the application roller 5. This arrangement results in a high torsional stiffness about the two axes that respectively lie transverse to the rotational axis of the application roller 5 such that the scraper 7 is always guided parallel to the application roller 5. The coupling mechanism 20 is situated outside the glue basin 4. The coupler 24 extends transverse to the plane of movement of the scraper and is supported by at least one additional grounded link 26. Thus, the coupler can be considered as having one element outside one side of the basin 4 another element outside the other side of the basin, with a connecting span (such as the scraper body) between them.

The linear motor 30 directly drives the coupler 24 and therefore the scraper 7. The primary component 31 is rigidly fixed on the frame and the secondary component 32 is arranged on the coupler 24. In this case, the primary motor component 31 with the hard-wired electric excitation coils is situated on a receptacle device 10 for the gluing station 1 while the coupling mechanism 20 with the permanent magnets of the secondary component 32 glued onto the coupler 24 is situated on the removable glue basin 4.

A position measuring system including a position sensor 33 and a measuring scale 34 is operatively connected to the linear drive 30. It is controlled by a drive control 35 that communicates with the machine control 36. The respective scraper 7 is initially closed (distance s is equal to zero). When a book block 2 approaches the application roller 5, the scraper 7 is opened by a definable distance s in dependence on the transport movement such that the applied glue layer begins at a definable distance from the front book block edge on the book block spine 2a. The scraper is accordingly closed once again when the rear book block edge reaches the application roller 5 such that the glue layer also ends at a definable distance from this book block edge. In two-up processing, the scraper 7 can also be briefly closed in the center of the block spine in order to maintain the region of the separating cut free of glue. The application position, application length and application thickness can be changed by means of the machine control 36.

When the linear drive 30 is switched off or the gluing station 1 is changed, the coupler 24 is supported on an adjustable stop 25 that simultaneously defines the zero position of the scraper 7 for completely scraping the glue 3 off the application roller 5.

FIG. 4 shows an alternative direct drive for the coupler 24. The coupler 24 features a crank 42, in which a cam 41 driven by a servomotor 40 is accommodated The distance s of the scraper 7 from the application roller 5 can be changed by turning the cam 41. In this case, the rotational movement of the output shaft of the servomotor 40 is geared down, i.e., the short stroke of the scraper 7 is generated by a relatively long rotational movement of the servomotor 40, wherein this has positive effects on the dynamics of the drive.

FIG. 5 shows another alternative of a direct drive. The coupler 24 is connected to the linearly movable coil part 51 of a moving coil 50.

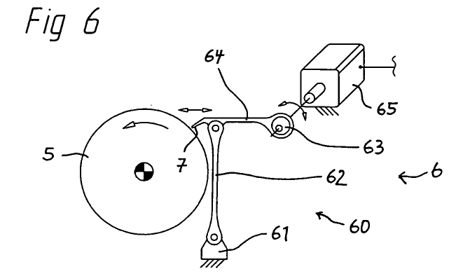

FIG. 6 shows a second embodiment of a four bar coupling mechanism 60. It consists of a grounded link 62 that is rotationally supported in the frame 61 and to the other end of which a coupler 64 with the scraper 7 arranged thereon is rotatably coupled. A cam 63 driven by a servomotor 65 is accommodated in another pivot bearing on the end of the coupler 64. The cam 63 that is rigidly and rotatably supported in the frame by the servomotor 65 represents a second grounded link of the coupling mechanism 60. The scraper 7 essentially is adjusted as in the embodiment according to FIG. 4. The grounded link 62 may also consist of a bending rod in the form of a leaf spring that is firmly clamped in place on both ends as in the embodiment according to FIGS. 1 to 5.

1. A device for applying glue onto a book block having a spine, comprising:
a book block transport mechanism;
a glue basin;
at least one application roller that rotates about a roller axis and dips into the glue basin such that a circumferential surface of the roller rolls on the book block spine as the book block spine is transported over the basin in a process direction;
a scraper confronting the circumferential surface of the application roller, which scraper is adjustable with respect to distance(s) from the application roller and thereby defines a glue layer thickness to be transferred onto the book block spine;
wherein the scraper is carried by a coupler of an at least four-bar coupling mechanism.

2. The device according to claim 1, wherein coupling mechanism has a ground link, two grounded links, and said coupler, and the grounded links are bending rods having respective lower ends firmly clamped to the ground link and respective upper ends firmly clamped to the coupler.

3. The device according to claim 2, wherein the bending rods are leaf springs having substantially planar surfaces that are arranged parallel to the axis of the application roller.

4. The device according to claim 1, wherein the coupling mechanism is a parallel mechanism with grounded links of equal length.

5. The device according to claim 1, wherein
the coupling mechanism is arranged outside the glue basin; and
at least one of the coupler or scraper extends transverse to the process direction to a remote end and is supported at the remote end by a guide that is flexible in the process direction and rigid transverse to the process direction.

6. The device according to claim 1, wherein the coupling mechanism with the scraper is arranged on a removable glue basin.

7. The device according to claim 1, wherein a drive mechanism is operatively connected to the coupler and controls the distance of the scraper from the application roller by adjusting the position of the coupler along the process direction.

8. The device of claim 7, wherein the drive mechanism is a gearless, linear electric direct drive.

9. The device according to claim 8, wherein the linear electric drive has a primary component containing electric excitation coils and a secondary component containing permanent magnets operatively connected to the coupler.

10. The device according to claim 9, wherein the bars of the coupling mechanism are fixed to one side of the coupler and the primary component of the direct drive is stationary adjacent a side of the coupler that is opposite said one side of the coupler.

11. The device according to claim 9, wherein the coupling mechanism with the scraper are arranged on a removable glue basin and the primary component is arranged on a receptacle for the removable glue basin.

12. The device according to claim wherein 8, wherein the scraper returns to a neutral position at a predefined defined distance from the application roller when the direct drive is switched off.

13. The device according to claim 1, wherein
the scraper is operatively connected a guide mechanism including multiple bending bars having upper and lower ends with the upper ends of the bars fixed to the coupler and the lower ends fixed to a frame such that the guide mechanism is flexible in the process direction and rigid transverse to the process direction;
a drive mechanism is operatively connected to the coupler and the coupler is operatively connected to the scraper whereby the drive mechanism controls the distance of the scraper from the circumferential surface of the application roller by adjusting the position of the coupler along the process direction;
the guide mechanism is arranged outside the glue basin;
the glue basin is removably situated in a basin receptacle; and
at least one of the coupler or scraper extends transverse to the process direction to a remote end and is supported at the remote end by another guide outside the glue basin that is flexible in the process direction and rigid transverse to the process direction.

14. A device for applying glue onto a book block having a spine, comprising:
a book block transporter that transports book blocks in a process direction;
a glue basin;
an application roller having an axis of rotation perpendicular to the process direction, wherein said roller dips into the glue basin and has a circumferential surface that applies glue by rolling on the book block spine as the book block is transported in the process direction; and
a scraper at an adjustable distance from the circumferential surface of the application roller which scraper defines a glue layer thickness to be transferred from the circumferential surface onto the book block spine;
wherein the scraper is connected to a coupler of a guide mechanism that is flexible in the process direction and rigid transverse to the process direction; and
wherein a drive mechanism is operatively connected to the coupler and controls the distance of the scraper from the circumferential surface of the application roller by adjusting the position of the coupler along the process direction.

15. The device of claim 14, wherein the guide mechanism comprises a four-bar coupling and the scraper is connected to coupler of the four bar coupling.

16. The device of claim 15, wherein the four bars include two grounded links having respective upper and lower ends, with said lower ends fixed in a stationary frame and said upper ends fixed in the coupler.

17. The device according to claim 16, wherein the grounded links are leaf springs that have substantially planar surfaces arranged parallel to the rotation axis of the application roller.

18. The device according to claim 16, wherein the coupling mechanism is a parallel mechanism with grounded links of equal length.

19. The device according to claim 16, wherein
the coupling mechanism is outside one side of the glue basin; and
at least one of the coupler or scraper extends to and protrudes from the other side of the basin transverse to the process direction and is supported outside said other end of the basin by another guide mechanism that is flexible in the process direction and rigid transverse to the process direction.

20. The device according to claim 16, wherein the drive mechanism is a gearless, linear electric direct drive.
